(19) United States
(12) Patent Application Publication
(10) Pub. No.: US 2026/0147650 A1
(43) Pub. Date: May 28, 2026

(54) SYSTEMS AND METHODS FOR ASSESSING ESSENTIAL SERVICES FITNESS SCORES AND RESPONDING THERETO

(71) Applicant: JPMORGAN CHASE BANK, N.A., New York, NY (US)

(72) Inventors: Joanne K. JARVIS, Oldsmar, FL (US); Andrew HARDING, London (GB); Nicola ALI, Ridgewood, NJ (US)

(21) Appl. No.: 19/387,232

(22) Filed: Nov. 12, 2025

Related U.S. Application Data
(60) Provisional application No. 63/725,334, filed on Nov. 26, 2024.

(51) Int. Cl. G06F 11/00

(52) U.S. Cl. CPC G06F 11/004; G06F 2201/81

(57) ABSTRACT

Systems and methods for assessing essential services fitness scores and responding thereto are disclosed. According to an embodiment, a method may include: receiving, by a computer program executed by an electronic device, data points from a plurality of computing assets; retrieving, by the computer program, a mapping of the plurality of computing assets to essential services; calculating, by the computer program, a fitness score for each essential service using the data points and the mapping; generating, by the computer program, a report comprising the fitness score for each of the essential services; and executing, by the computer program, a corrective action in response to one of the fitness scores being below a threshold.

### RELATED APPLICATIONS

This application claims priority to, and the benefit of, U.S. Provisional Patent Application Ser. No. 63/725,334, filed Nov. 26, 2024, the disclosure of which is hereby incorporated, by reference, in its entirety.

### BACKGROUND OF THE INVENTION

### 1. Field of the Invention

Embodiments relate to systems and methods for assessing essential services fitness scores and responding thereto.

### 2. Description of the Related Art

Within a large organization, managers, and owners of essential services (e.g., computing services that are required for the organization to operate, such as liquidating and distributing assets in investment portfolios, providing access to funds, investment management, client-facing websites and applications, etc.) often do not have visibility into all the different vulnerabilities of their services. While they may be aware of certain things, there is not a holistic view of all the vulnerabilities/risks that could impact their essential services.

### SUMMARY OF THE INVENTION

Systems and methods for assessing essential services fitness scores and responding thereto are disclosed. According to an embodiment, a method may include: receiving, by a computer program executed by an electronic device, data points from a plurality of computing assets; retrieving, by the computer program, a mapping of the plurality of computing assets to essential services; calculating, by the computer program, a fitness score for each essential service using the data points and the mapping; generating, by the computer program, a report comprising the fitness score for each of the essential services; and executing, by the computer program, a corrective action in response to one of the fitness scores being below a threshold.

In one embodiment, the computing assets may include servers and databases.

In one embodiment, the data points indicate compliance of the computing asset with controls to mitigate a technical risk, a recovery time, and/or a security issue.

In one embodiment, the data points indicate compliance of the computing asset with controls to mitigate business risk.

In one embodiment, the method may also include: identifying, by the computer program, the computing assets as critical points of failure.

In one embodiment, the method may also include: identifying, by the computer program, the computing assets used by one of the essential services; and generating, by the computer program, the mapping for the essential service based on the identification.

In one embodiment, the step of calculating the fitness score for each essential service using the data points and the mapping may include: weighting, by the computer program, each of the data points based on a historical impact on the computing asset.

In one embodiment, the method may also include: predicting, by the computer program, the fitness score for one of the computing assets based on a history of vulnerabilities for the computing asset.

In one embodiment, the step of executing the corrective action in response to one of the fitness scores being below the threshold may include: executing, by the computer program, a self-healing action.

In one embodiment, the step of executing the corrective action in response to one of the fitness scores being below the threshold may include: automatically re-routing, by the computer program, log ins for an application that is part of one of the essential services to an alternate computing asset.

According to another embodiment, a system may include: a plurality of computing assets; and an electronic device executing a computer program that may be configured to: receive data points from the plurality of computing assets; retrieve a mapping of the plurality of computing assets to essential services; calculate a fitness score for each essential service using the data points and the mapping; generate a report comprising the fitness score for each of the essential services; and execute a corrective action in response to one of the fitness scores being below a threshold.

In one embodiment, the computing assets may include servers and databases.

In one embodiment, the data points indicate compliance of the computing asset with controls to mitigate a technical risk, a recovery time, and/or a security issue.

In one embodiment, the data points indicate compliance of the computing asset with controls to mitigate business risk.

In one embodiment, the computer program may be further configured to identify the computing assets as critical points of failure.

In one embodiment, the computer program may be further configured to identify the computing assets used by one of the essential services, and to generate the mapping for the essential service based on the identification.

In one embodiment, the fitness score for each essential service may be calculated by weighting each of the data points based on a historical impact on the computing asset.

In one embodiment, the computer program may be further configured to predict the fitness score for one of the computing assets based on a history of vulnerabilities for the computing asset.

In one embodiment, the corrective action may include a self-healing action.

In one embodiment, the corrective action may include automatically re-routing logins for an application that is part of one of the essential services to an alternate computing asset.

### BRIEF DESCRIPTION OF THE DRAWINGS

For a more complete understanding of the present invention, the objects, and advantages thereof, reference is now made to the following descriptions taken in connection with the accompanying drawings in which:

FIG. 1 illustrates a system for assessing essential services fitness scores and responding thereto according to an embodiment;

FIG. 2 illustrates a method for assessing essential services fitness scores and responding thereto according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for assessing essential services fitness scores and responding thereto.

In embodiments, a computer program may collect vulnerability/fitness data from various systems to assess how these data points impact essential services, such as services that are critical for the operation of an organization. The essential services may include one or more computer applications that are used with the essential service.

In the banking industry, examples of example services include customer-facing services, such as online banking, tax preparation, automated teller machine service, etc.

The computer program may collect a variety of data points measuring compliance of computing assets that support the essential services. The computing assets that support the essential services may be referred to as Critical Point of Failure (CPOF) assets.

The data points may be aggregated, thereby providing an overall assessment of the fitness of essential service (or the risk to each essential service). This may indicate the number of instances where the essential service is impacted. Individual fitness scores may be calculated, weighted, and then aggregated. For example, every instance of the use of a CPOF computing asset in the essential service is calculated into the score. Several other data points may be gathered and applied in the same way, showing where the risk is impacting the essential services.

In one embodiment, the data points may be aggregated into a weighted score, such as a score ranging from 0 to 100, where 100 represents the optimal state. Other scoring systems (e.g., letter, color, etc.) may be used as is necessary and/or desired.

The fitness score may provide a clear, quantifiable measure of the fitness of each essential service.

The fitness scores for all essential services may be provided in a fitness report, which may identify the fitness of each essential services.

Embodiments may facilitate predictive analysis of incidents. For example, an increase in incidents shows increasing vulnerabilities in the computing assets (e.g., hardware, coding, etc.),

Embodiments may provide preemptive resiliency. For example, in response to an increase in political unrest in region, embodiment may ensure work transfer strategies are in place, tested, etc. to minimize or eliminate risk to essential services.

Embodiments may assess operational fitness. For example, using the same data, embodiments may review the plan fitness (e.g., fitness of sub-systems) to sure that the plan fitness is in compliance.

Embodiments may automate the fixing of identified issues. For example, in response to the identification of an issue with an essential service, embodiments may automatically implement a work from home strategy, may invoke alternate computing assets for any impacted CPOF assets, may transfer the service/work to an alternate site, may implement software updates/patches, etc.

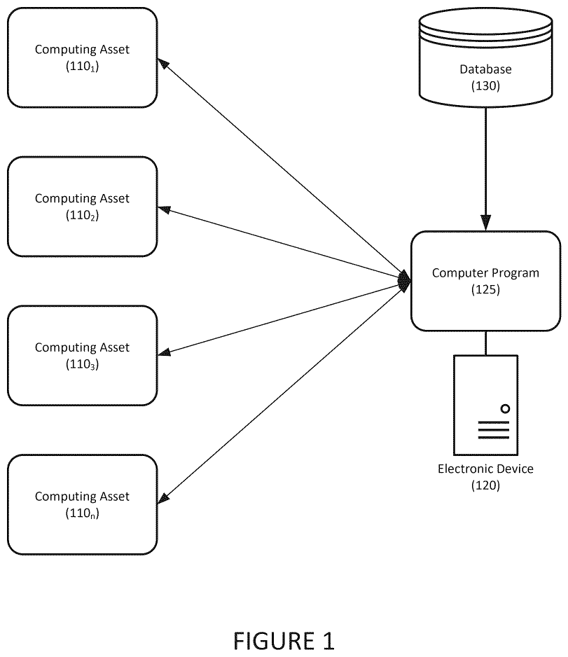

Referring to FIG. 1, a system for assessing essential services fitness scores and responding thereto is disclosed according to an embodiment. System 100 may include a plurality of computing assets 110 (e.g., computing assets 110₁, 110₂, 110₃. . . 110ₙ) that may interface with computer program 125 executed by electronic device 120. Computing assets 110 may include computing assets that support essential services to an organization, such as CPOFs. Examples of computing assets include servers, database, applications, third party vendors, infrastructure, etc.

Database 130 may store a mapping or a link between essential services and one or more computing assets 110. The essential services may be manually identified by the business based on their criticality to the operation of the business. Each essential service may be linked or associated with one or more computing asset 110 upon which it relies on to function.

If losing one of computing assets 110 would significantly disrupt the service and potentially cause intolerable harm, then that computing asset 110 is identified as a CPOF.

In one embodiment, when one of computing assets 110 is used by an essential service, computing program 125 may track its use. For example, if an essential service, such as a trading operation, depends on a news feed service, the news feed service is linked to the trading operation. If the news feed service becomes unavailable, it could cause the trading service to fail, making the news feed service a CPOF for the trading operation.

Computer program 125 may receive data points from computing assets 110 and may assess how the data points impact the essential services, thereby assessing a fitness of each essential service. For example, computer program 125 may receive technical data points, application change data points, application management data points, technical risk profile data points, and business resiliency data points.

In one embodiment, the data points may only be received from computing assets that are identified as or determined to be CPOFs.

In general, for each computing asset 110, the data points may indicate compliance with controls (e.g., policies, procedures, or technical measures put in place to manage risks and ensure objectives are met) to mitigate risk, recovery time, failover testing, backups, etc. as well as security, and the availability of workarounds as needed. For example, the datapoints that are collected may identify whether a CPOF computing asset 110 is compliance with a control, such as compliance with sustained resiliency testing. If it has not, then CPOF computing asset 110 is out of compliance and presents a risk to the associated essential service(s).

The data points may also indicate the recovery time for computing assets 110. Thus, a longer recovery time will receive a lower score than a faster recovery time.

The data points may indicate whether computing assets 110 have successful failover testing should the computing asset become unavailable.

The data points may indicate whether computing assets 110 are backed up, whether applications used by essential services comply with any applicable security requirements, whether there are workarounds in place should any of computing assets 110 become unavailable, etc.

After receiving the data points, computer program 125 may generate a score to quantify the fitness of the essential services. In one embodiment, the score may be a weighted score, for example, ranging from 0 to 100, where 100 represents the optimal state. Any suitable scoring scheme may be used as is necessary and/or desired. These scores may be calculated based on computing assets 110 that support each essential service and any issues they may have. The score may provide a clear, quantifiable measure of essential service risks.

Computer program 125 may implement automated healing, automate remediation, etc. in response to a score being below a threshold.

Computer program 125 may also provide predictive analysis for computing assets 110. For example, an increase in incidents involving one of the computing assets 110 may be indicative of increasing vulnerabilities for that computing asset 110.

Computer program 125 may also provide preemptive resiliency for the essential services. For example, in response to an increase in political unrest in region, computer program may ensure that work transfer strategies are in place and tested, and may implement those strategies.

Computer program 125 may assess operational fitness through analysis of trigger events, such as when an application that is part of an essential service fails, or a critical site that provides essential services or CPOF computing assets 110 may be impacted by a hurricane. These events may initiate the assessment.

In one embodiment, some computing assets 110 may be used by multiple essential services. This data may be used to show the risk that each computing asset 110 presents to each essential service, but to also see how one computing asset 110 impacts multiple essential services, etc.

Computer program 125 may also automate the fixing of any identified issues by, for example, transferring work to another computing asset 110 if one is at a certain fitness level, by invoking a work from home strategy if needed to minimize the impact on a CPOF computing asset 110, etc.

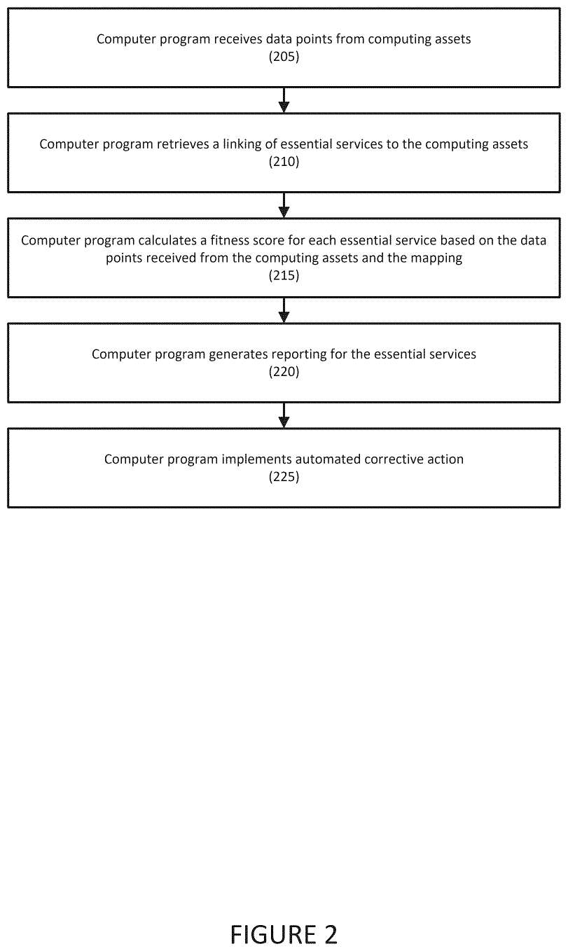

Referring to FIG. 2, a method for assessing essential services fitness scores and responding thereto is disclosed according to an embodiment.

In step 205, a computer program executed by an electronic device may receive data points from a plurality of computing assets, such as servers, databases, etc. For example, the data points may include technical data points, application change data points, application management data points, technical risk profile data points, and business resiliency data points. In general, for each computing asset, the data points may indicate compliance with controls to mitigate risk, recovery time, failover testing, failover testing, backups, etc. as well as security, and workarounds as needed.

In one embodiment, an agent executed by each of the computing assets may push the data points to the computer program periodically or as necessary and/or desired. Alternatively, the computing program may pull the data points from the computing assets periodically or as necessary and/or desired.

In step 210, the computer program may retrieve a mapping or a linking of essential services to one or more of the computing assets. In one embodiment, the mapping may be retrieved from a database.

In step 215, the computer program may calculate a score for each essential service based on the data points received from the computing assets and the mapping.

In one embodiment, the computer program may use a weighting for each data point. For example, certain data points are more likely to indicate an issue than others. Thus, those data points may receive a greater weighting than those that do not.

In one embodiment, the weighting may be determined using a machine learning engine that is trained with historical data. For example, the machine learning engine may be trained with historical data points and incidents and may predict the impact of the data point on a likelihood of having an incident.

In one embodiment, each data point may be assigned a score ranging, for example, from 1-5, with 5 indicating high fitness, and 5 indicating low fitness.

In one embodiment, the score may be a weighted score, for example, ranging from 0 to 100, where 100 represents the optimal state. Any suitable scoring scheme may be used as is necessary and/or desired. These scores may be calculated based on the computing assets that support each essential service and any issues they may have. The score may provide a clear, quantifiable measure of essential service fitness.

In one embodiment, the computer program may use predictive analysis to predict the score for a computing asset. Predictive analysis is based on a history of vulnerabilities for the computing asset. If a computing asset habitually out of compliance, this may be an indicator that there is a coding issue that must be resolved, or infrastructure that needs to be upgraded.

In step 220, the computer program may generate reporting, such as drill-down reporting. The reporting may identify, for example, each essential service, the health of its computing assets, health, the resilience of its computing assets, the score, and any trends (e.g., score increasing, decreasing, etc.).

For example, for the health of the CPOF computing assets, the report may identify an impact of a major incident on the CPOF computing asset, a finding for applications violating a control in a vulnerability management control domain, technical risk profiles (e.g., a risk profile for the CPOF computing asset), a vulnerability to the CPOF computing asset being exploited, etc. as well as security configuration findings that increase the likelihood of a successful compromise of the CPOF computing asset, a geographic concentration risk to the CPOF computing asset (e.g., the risk of a significant business impact due to a partial or complete unavailability of staff and/or site assets in a given geography, such a city or country), any open high concerns, open business center/Disaster Recovery issues on supplier engagement for the CPOF computing asset, a recovery time capability for a applications using the CPOF computing asset, and a maximum time an essential service can be down before intolerable harm might occur.

Other elements and risks may be identified by the report as is necessary and/or desired.

For the resilience of the computing assets, the report may include similar elements, such as whether there are workarounds for computing asset failure, an impact of a major incident on resiliency, technical resiliency, recovery backup availability, geographic concentration risk, open high concerns, etc.

In step 225, the computer program may implement automated corrective action in response to a score being above a threshold. For example, the computer program may implement self-healing, auto-remediation, and/or digital twins; may implement cross-enterprise risk sharing and/or supply chain integration; AI-driven forecasting and prescriptive playbooks, etc.

The threshold may be dynamic and set using machine learning, or it may be static and set by a user.

The threshold may set a level of unacceptable risk to the essential service.

For example, once the scores are calculated, if they are below the threshold, the computer program may notify a manager via email or SMS to use an alternate asset. In one embodiment, the computer program may automatically re-route the logins of users of the essential services to alternate assets. Thus, the users will not know that they are being re-routed to the alternate asset. Instead of getting an error when they try to login to the failed application, they are re-routed and successfully log in.

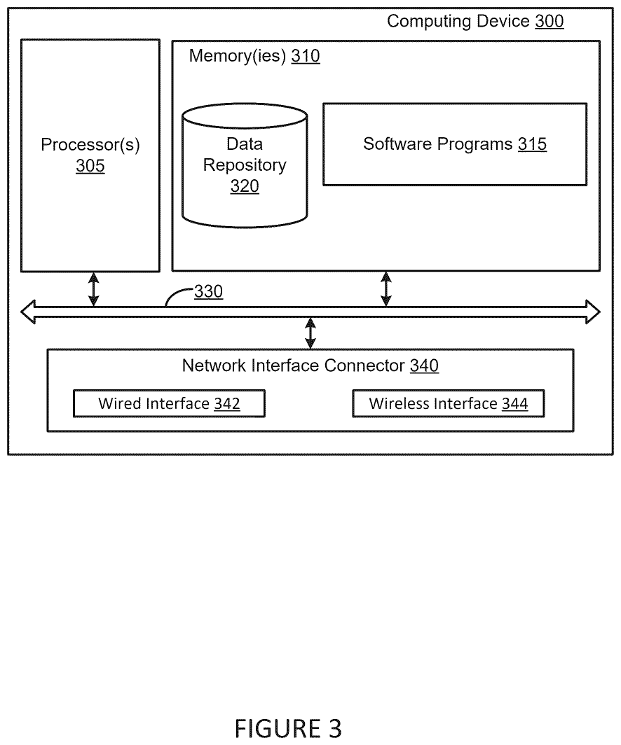

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
receiving, by a computer program executed by an electronic device, data points from a plurality of computing assets;
retrieving, by the computer program, a mapping of the plurality of computing assets to essential services;
calculating, by the computer program, a fitness score for each essential service using the data points and the mapping;
generating, by the computer program, a report comprising the fitness score for each of the essential services; and
executing, by the computer program, a corrective action in response to one of the fitness scores being below a threshold.

2. The method of claim 1, wherein the computing assets comprise servers and databases.

3. The method of claim 1, wherein the data points indicate compliance of the computing asset with controls to mitigate a technical risk, a recovery time, and/or a security issue.

4. The method of claim 1, wherein the data points indicate compliance of the computing asset with controls to mitigate business risk.

5. The method of claim 1, further comprising:
identifying, by the computer program, the computing assets as critical points of failure.

6. The method of claim 1, further comprising:
identifying, by the computer program, the computing assets used by one of the essential services; and
generating, by the computer program, the mapping for the essential service based on the identification.

7. The method of claim 1, wherein the step of calculating the fitness score for each essential service using the data points and the mapping comprises:
weighting, by the computer program, each of the data points based on a historical impact on the computing asset.

8. The method of claim 1, further comprising:
predicting, by the computer program, the fitness score for one of the computing assets based on a history of vulnerabilities for the computing asset.

9. The method of claim 1, wherein the step of executing the corrective action in response to one of the fitness scores being below the threshold comprises:
executing, by the computer program, a self-healing action.

10. The method of claim 1, wherein the step of executing the corrective action in response to one of the fitness scores being below the threshold comprises:
automatically re-routing, by the computer program, logins for an application that is part of one of the essential services to an alternate computing asset.

11. A system, comprising:
a plurality of computing assets; and
an electronic device executing a computer program that is configured to:
receive data points from the plurality of computing assets; retrieve a mapping of the plurality of computing assets to essential services; calculate a fitness score for each essential service using the data points and the mapping; generate a report comprising the fitness score for each of the essential services; and execute a corrective action in response to one of the fitness scores being below a threshold.

12. The system of claim 11, wherein the computing assets comprise servers and databases.

13. The system of claim 11, wherein the data points indicate compliance of the computing asset with controls to mitigate a technical risk, a recovery time, and/or a security issue.

14. The system of claim 11, wherein the data points indicate compliance of the computing asset with controls to mitigate business risk.

15. The system of claim 11, wherein the computer program is further configured to identify the computing assets as critical points of failure.

16. The system of claim 11, wherein the computer program is further configured to identify the computing assets used by one of the essential services, and to generate the mapping for the essential service based on the identification.

17. The system of claim 11, wherein the fitness score for each essential service is calculated by weighting each of the data points based on a historical impact on the computing asset.

18. The system of claim 11, wherein the computer program is further configured to predict the fitness score for one of the computing assets based on a history of vulnerabilities for the computing asset.

19. The system of claim 11, wherein the corrective action comprises a self-healing action.

20. The system of claim 11, wherein the corrective action comprises automatically re-routing log ins for an application that is part of one of the essential services to an alternate computing asset.
